(19) United States
(12) Patent Application Publication
(10) Pub. No.: US 2020/0027057 A1
(43) Pub. Date: Jan. 23, 2020

(54) HANDOVER CHECKING METHOD FOR TRANSPORTED ARTICLES, MONITORING DEVICE AND CENTRAL PROCESSING SYSTEM

(71) Applicants: Rudi SCHEINER, Hamburg (DE); Cargo-Bee Solutions GmbH, Hamburg (DE)

(72) Inventors: Rudi SCHEINER, Hamburg (DE); Henning FREDERSDORF, Hamburg (DE); Jürgen LANKAT, Hamburg (DE); Georg H. VÖLKER, Hamburg (DE)

(73) Assignee: Cargo-Bee Solutions GmbH, Hamburg (DE)

(21) Appl. No.: 16/338,384

(22) PCT Filed: Sep. 29, 2017
(86) PCT No.: PCT/EP2017/074780

§ 371 Date: Mar. 29, 2019

(30) Foreign Application Priority Data
Sep. 30, 2016 (DE) 10 2016 118 586.8

(51) Int. Cl. G06Q 10/08; B60R 25/00; G06Q 50/30; H04W 4/021; B64C 39/02

(52) U.S. Cl. CPC G06Q 10/0833; G06Q 10/087; B60R 25/00; B64C 39/024; G06Q 10/0832; H04W 4/021; G06Q 50/30

(57) ABSTRACT

The invention relates to a a method for checking that the articles to be transported have been handed over properly at their destination, which includes the steps: generating first checking information for a certain transport of a certain transport article to a certain destination at which the transport article is to be handed over to a recipient based on location information concerning the certain destination and identification information identifying the transport article; storing the first checking information in a central processing system; transmitting the location information concerning the certain destination to a monitoring device of the transporter, wherein the monitoring device comprises a position determining module, and transmitting the identification information to the recipient; for successfully checking of the handover, determining, by the monitoring device, location information relating to the location at which the articles to be transported are handed over to the recipient; reading the identification information into the monitoring apparatus; transmitting second checking information based on the determined location information relating to the location and the identification information by the monitoring apparatus to the central processing system; and checking whether the first checking information matches the second checking information to the extent that the identification information is identical and the location is within a specific area around the destination. The verification of the correct handover of the transported articles is only considered successful if the first checking information matches the second checking information.

The present invention is directed to a method for checking the proper handover of a transported article at its destination, a monitoring device and a central processing system for such a check.

The need to transport articles from one place to another is omnipresent. The articles are usually packed or stored in containers such as small parcels, parcels, transport boxes, containers or the like. In the following, articles in unpacked or packaged form are generally referred to as transported articles. In the case of such transports, the dispatcher and the recipient run the risk that the articles to be transported, or parts thereof, may disappear on the transport route and that the associated economic damage may result.

Various solutions have been devised to reduce this risk and to better monitor the transport of articles. In particular, articles being transported are now provided with transponders which enable them to be located, for example on the basis of the Global Positioning System (GPS). In addition, the transfers from the dispatcher to the transporter and from the transporter to the recipient with so-called waybills or comparable documents are partly also handled electronically. However, the waybills or comparable documents, regardless of the nature of their existence, have considerable disadvantages. In particular, their susceptibility to forgery or the problem that it is not verifiable whether the handover noted on the consignment note was actually carried out by the recipient at the intended location should be mentioned here. This is because it may happen that the transporter and the recipient fraudulently agree that the articles to be transported are handed over at a place other than the intended place but are acknowledged as having been handed over properly. Another possibility is to forge the signature on the consignment note. For example, the dispatcher may suffer an economic loss if the consignment note states that the articles have been duly handed over even though they are not in their intended location.

It is therefore an object of the invention to propose a method, a monitoring device and a central processing system with which it can be checked whether the articles to be transported have been properly processed.

In accordance with the invention, this object is solved by a method for checking that the articles to be transported have been handed over properly at their destination, which includes the steps: generating first checking information for a certain transport of a certain transport article to a certain destination at which the transport article is to be handed over to a recipient based on location information concerning the certain destination and identification information identifying the transport article; storing the first checking information in a central processing system; transmitting the location information concerning the certain destination to a monitoring device of the transporter, wherein the monitoring device comprises a position determining module, and transmitting the identification information to the recipient; for successfully checking of the handover, determining, by the monitoring device, location information relating to the location at which the articles to be transported are handed over to the recipient; reading the identification information into the monitoring apparatus; transmitting second checking information based on the determined location information relating to the location and the identification information by the monitoring apparatus to the central processing system; and checking whether the first checking information matches the second checking information to the extent that the identification information is identical and the location is within a specific area around the destination. According to the invention, the verification of the correct handover of the transported articles is only considered successful if the first checking information matches the second checking information.

The method according to the invention checks whether the articles to be transported were actually transferred to the recipient of the transported articles at the specified destination. This prevents the handover of the articles to be transported from being regarded as correct even though the transporter has handed over the articles to be transported to the recipient at a location other than the specified destination or the transporter has handed over the articles to be transported to a recipient other than the specified recipient. It is also possible to avoid pretending that the articles have been handed over properly by forging the signature.

According to another aspect of the present invention, it is proposed that the method also covers: verifying whether the determined location information and the location information relating to the certain destination coincide to the extent that the location is within a particular area around the destination, and generating location verification result information indicating whether or not the location information coincides based on the result of the verification. The second checking information is generated based on the location verification result information and the identification information, and the first checking information and the second checking information are considered to match if the location verification result information indicates that the determined location information and the location information relating to the certain destination match and the identification information is identical.

This further improves the procedure according to the invention, because the verification of the location information already takes place in the monitoring device and thus it can be immediately signalled to the recipient as well as the transporter that the location of the intended transfer does not correspond to the destination.

According to another aspect of the present invention, reading in the identification information involves scanning the identification information transmitted to the recipient by the monitoring device, or inputting the transmitted identification information into the monitoring device.

This improves the reading of the identification information into the monitoring device and enables the use of different codes for the identification information, such as a quick response (QR) code or a barcode.

According to another aspect of the present invention, the first checking information is also generated and transmitted to the transporter's monitoring device based on time information relating to a specified period of time, during which the transported articles are to be handed over to the recipient. The method according to this further aspect further comprises: determining time information relating to the time at which the transported articles are handed over to the recipient by a time determination module of the monitoring device; and checking whether the determined time information and the time information relating to the specified period of time coincide to the extent that the time is within the specified time period. The verification of the proper handover of the articles to be transported is considered successful only if the determined time information and the time information relating to the specified time period coincide.

This further improves the method in accordance with the invention and its security, because in addition to the specific destination and the specific recipient, it also ensures that the transfer takes place at the specified, i.e. scheduled, time.

In addition, according to a further aspect of the inventive method, the second checking information may also be based on the determined time information and verifying the checking information may further include verifying whether the first checking information matches the second checking information to the extent that the time is within the specified time period.

This improves the method in accordance with the invention to the extent that not only is the reading in of the identification information prevented or made possible by the monitoring device, but also that it is possible to check the proper handover using the information relating to the transport.

According to other aspects, the method according to the invention can also include: marking the first checking information when the first checking information matches the second checking information. The marking of the first checking information includes in particular deactivating the first checking information. It is also preferable that the verifying whether the checking information matches includes checking whether the first checking information has already been deactivated.

In particular, this ensures that transports, which use information that has been stolen, for example, or which originates from transports, that have already been completed, cannot be used.

According to other aspects, the method according to the invention can also include: Generating the first checking information based on a monitoring device ID that identifies the monitoring device.

This allows verification that the correct driver is receiving the articles at the start of the journey and is handing them over at the destination point.

According to other aspects, the method according to the invention can also include: Generating the first checking information based on a vehicle ID identifying the transport vehicle.

This allows to verify whether the articles are loaded onto the correct vehicle at the start of the transport and unloaded from the correct vehicle at the point of handover.

According to other aspects, the method according to the invention can also include: At the beginning of the transport, the monitoring device ID is transmitted to the central processing system and the monitoring device ID is checked by comparison with the first checking information.

In this way, it is specifically determined whether the correct driver received the articles at the start of the transport.

According to other aspects, the method according to the invention can also include: At the beginning of the transport, the vehicle ID is transmitted to the central processing system and the vehicle ID is checked by comparison with the first checking information.

In this way, it can be specifically checked whether the articles have been loaded onto the correct vehicle.

According to other aspects, the method according to the invention can also include: At the handover location, the second checking information is transmitted to the central processing system, which is based, inter alia, on the monitoring device ID and/or the vehicle ID, and verifying the second checking information, and thus the monitoring device ID and/or the vehicle ID, by comparison with the first checking information.

In this way it can be verified at the point of delivery that the articles have been delivered by the correct driver and/or vehicle.

According to other aspects, the method of the invention may also include the following: The monitoring device is designed as a mobile monitoring device, in particular a tablet or smartphone, which is assigned in the central processing system either permanently or at least for a specific transport by assignment to a specific driver.

This provides identification of the driver and verification of his assignment to the monitoring device ID. The assignment can be made by the administrator of the central processing system, for example.

According to other aspects, the method according to the invention can also include: The monitoring device is designed as an on-board unit OBU fixed to a particular vehicle and in the central processing system the monitoring device is linked to or associated with the particular vehicle by its monitoring device ID by association with the vehicle ID of the particular vehicle.

In this way, a fixed association of vehicle and articles is made (by linking the vehicle ID with the order data). This ensures that the articles are loaded onto the correct vehicle. By further taking into account the monitoring device ID (if necessary by authenticating the driver towards the monitoring device by PIN or password) in one embodiment, it is even possible to generate an association of driver, articles and vehicle to each other. This ensures on the one hand that the articles are loaded onto the correct vehicle and on the other hand that they are transported and handed over by the correct driver.

According to other aspects, the method according to the invention assigns a password to a driver either permanently or for a specific transport, by which he must log on to the monitoring device,

the monitoring device is configured such that the password assigned to the driver at the beginning of the transport is requested by the driver for login, and

the password and the driver associated with the password are stored in the central processing apparatus and, optionally, the first checking information is generated based thereon.

A password can be used to assign a specific driver to a particular transport, even if the OBU is permanently installed and the driver changes, and to verify the driver's identity when the articles are picked up and at the point of delivery.

According to another aspect of the present invention, the method according to the invention also includes: generating third checking information for a specific transport of specific transport articles based on location information related to a starting point, at which the transport articles are to be handed over from a dispatcher to the transporter and based on the identification information; storing the third checking information in the central processing system; transmitting the identification information to the dispatcher; transmitting the location information related to the starting point to the monitoring device of the transporter; determining a location information related to the ocation, at which the transport articles are handed over to the transporter, by the monitoring device, reading the identification information into the monitoring device, transmitting fourth checking information based on the determined location information related to the location and the identification information to the central processing system by the monitoring device; and checking whether the third checking information matches the fourth checking information to the extent that the identification information is identical and that the location is located within a certain area around the start location. The verification of the proper delivery of the articles to be transported is considered successful only if the third checking information matches the fourth checking information.

This further improves the method in accordance with the invention in such a way that a verification of a proper handover from the dispatcher to the transporter can be carried out. This prevents, in particular, that other articles are transported or that another transporter carries out the transport.

According to another aspect of the present invention, the method can further comprise: Marking the third checking information if the third checking information matches the fourth checking information. The marking of the third checking information includes in particular deactivating the third checking information. Preferably, the method according to this aspect, also includes that the verifying whether the checking information match includes a check whether the third checking information has already been deactivated. As already described above, this can prevent transports from being carried out using information that has been stolen, for example, or from transports that have already been completed.

It is advantageous if the identification information is a barcode or a QR code and/or the location information is location coordinates, in particular cartesian location coordinates or Global Positioning System (GPS) location coordinates, or an identifier which identifies an area around a location, such as a geofence ID.

According to the invention, the above-mentioned object is also solved by a method for checking the proper handover of transported articles at the start location, which comprises the steps: generating checking information for a particular transport of particular transport articles based on location information related to the starting point, at which the transport articles are to be handed over from a dispatcher to the transporter, and based on identification information identifying the transport articles; storing the generated checking information in a central processing system; transmitting the generated identification information to the dispatcher; transmitting the location information related to the starting point to a monitoring device of the transporter; determining a location information related to the location, at which the transport articles are handed over to the transporter, by the monitoring device; reading the identification information into the monitoring device; transmitting by the monitoring device to the central processing system checking information, which is based on the determined location information concerning the location and the identification information; and checking whether the generated checking information matches the transmitted checking information to the extent that the identification information is identical and that the location is within a certain area around the start location. The verification of the proper delivery of the articles to be transported is considered successful only if the third checking information matches the fourth checking information.

The method in accordance with the invention checks whether the articles to be transported have actually been transferred from the dispatcher to the transporter of the articles at the specified starting point. This prevents the transfer of the articles to be transported from being regarded as correct even though the dispatcher has transferred the articles to be transported to the transporter at a location other than the specified point of departure or the dispatcher has transferred the articles to be transported to a transporter other than the specified transporter. Likewise, it is possible to avoid forging the signature, as it is possible with the classic consignment note.

The present invention further proposes a monitoring device for verifying proper delivery of a transported article at the destination, the monitoring device being connectable to a central processing system according to the invention for generating and storing first verification information for a particular transport of a particular transported article to a particular destination, where the transported good is to be delivered to a recipient, based on location information concerning the particular destination and identification information identifying the transported article. The monitoring device comprises: a module for receiving location information relating to the designated destination; a position determining module adapted to determine location information relating to the location at which the transported articles are handed over to the recipient; a module for inputting the identification information which has been transmitted to the recipient; and a module for transmitting, by the monitoring device, second checking information based on the determined location information relating to the location and the identification information to the central processing system. The central processing system verifies whether the first checking information matches the second checking information to the extent that the identification information is identical and the location is within a certain area around the destination, and the verification of proper delivery of the transported article is considered successful only if the first checking information matches the second checking information.

Furthermore, the present invention proposes a central processing system for the examination of a proper handover of a transported article at the destination, which can be connected to a monitoring device according to the invention, which has a module for position determination. The central processing system comprises: a module for generating first checking information for a particular transport of a particular transport article to a particular destination at which the transport article is to be handed over to a recipient, based on location information concerning the particular destination and identification information identifying the transport article; a module for storing the first checking information; a module for transmitting the location information concerning the particular destination to the monitoring device of the transporter, the monitoring device having a module for position determination, and a module for transmitting the identification information to the recipient; a module for receiving second checking information from the monitoring device, the second checking information being based on location information determined by the monitoring device concerning the location at which the transported articles are handed over to the recipient and the identification information inputted into the monitoring device; and a module for verifying whether the first checking information matches the second checking information to the extent that the identification information is identical and the location is within a specific area around the destination. The verification of proper delivery of the transported articles is considered successful only if the first checking information matches the second checking information.

Preferred embodiments of the invention are explained below using non-restrictive examples with reference to the attached figures showing:

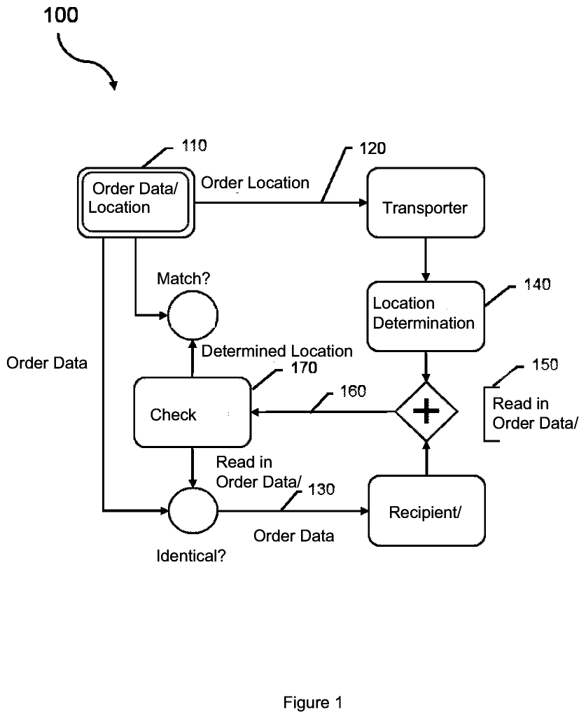

FIG. 1 is a flow chart showing a simplified and schematic representati of a method for verifying the proper handover of a transported article at the destination in accordance with an embodiment of the present invention,

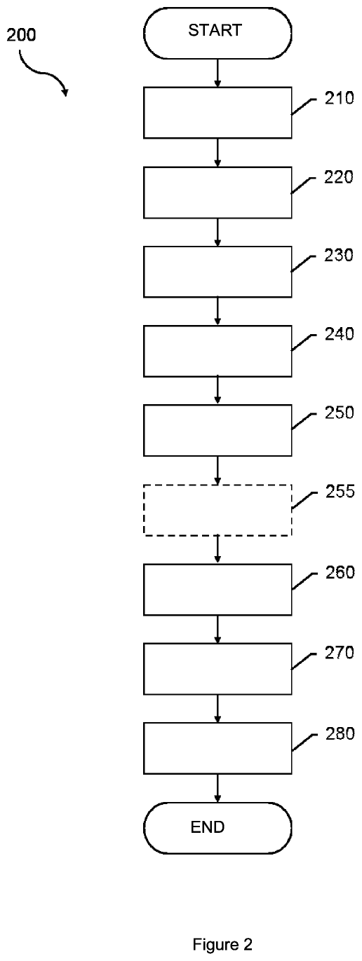

FIG. 2 is a flow chart showing a method for verifying the proper handover of a transported article at its destination according to a first embodiment of the present invention,

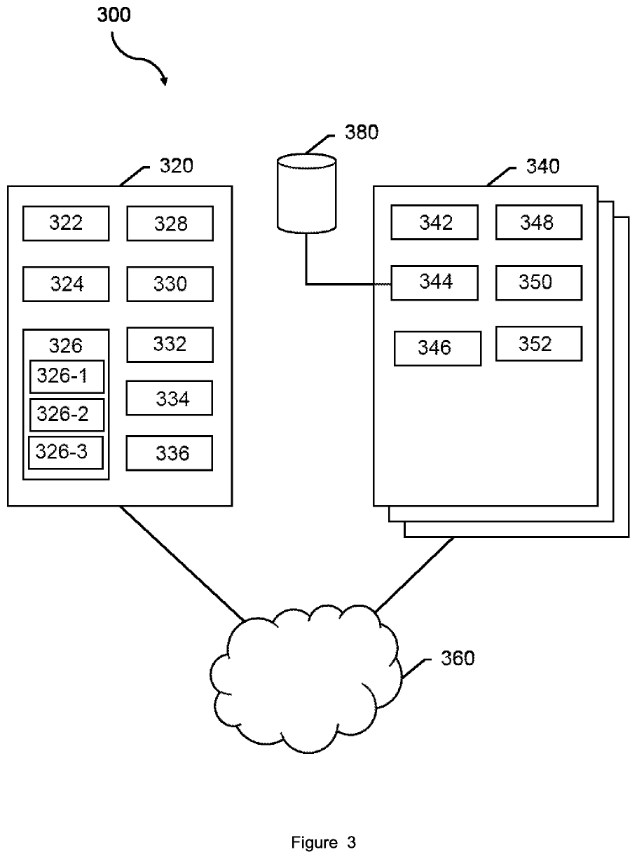

FIG. 3 is a schematic representation of a system comprising a monitoring device and a central processing system in accordance with an embodiment of the present invention.

A simplified embodiment of a method in accordance with the invention for checking the proper transfer of a transported article at its destination is described below with reference to the schematic representation in FIG. 1.

The method 100 shown in FIG. 1 starts with the generation of data related to an order (step 110). This data relates to a particular order (i.e. a transport of a particular article to a particular destination) and include order data and an order location (here the destination). The order (that is, the transport or the specific transport article) is identified by the order data and the order location. The data can be generated (step 110) on a central processing system, for example.

The generated data is stored in the central processing system. Furthermore, the location of the order is transmitted to the transporter or to a monitoring device (step 120) and the order data is transmitted to the recipient, i.e. to the one to whom the transported articles are to be handed over (step 130).

Furthermore, the monitoring device determines a location information concerning the location at which the transported articles are handed over to the recipient by the transporter (step 140) and allows the order data to be read in (step 150).

The determined location information and the order data, which have been read in, are then transmitted to the central processing system (step 160).

The central processing system then checks whether the transmitted order data is identical to the stored order data and whether the determined location information specifies a location that is located within a specific area around the stored order location that belongs to the stored order data (step 170).

If the check is successful, the check to ensure that the articles to be transported have been handed over correctly is regarded as successful; otherwise an incorrect handover (e.g. a handover to the wrong recipient or a handover at the wrong location) is determined.

In the following, with reference to FIG. 2, a method 200 is described in detail for checking the proper handover of a transported article at the destination according to a preferred first embodiment of the present invention.

In accordance with the first embodiment of method 200, it is ensured that the transfer of the transported articles to the recipient takes place at the specified destination.

Method 200 starts with a step 210 to generate first checking information for the transport of the transported articles to the destination. The first checking information is generated on the basis of location information concerning the destination and identification information identifying the transported articles.

The location information relating to the destination (referred to in FIG. 1 as the order location) may include, for example, location coordinates, in particular Cartesian location coordinates or location coordinates in accordance with the Global Positioning System (GPS) or a mobile cell identifier (CID) of a radio cell of a mobile radio system. However, it is preferable if the location information is an identifier that identifies an area around a location.

The area around the location forms an imaginary boundary on the earth's surface or in the air. The boundary preferably defines a closed area in such a way that a distinction can be made between inside (i.e. inside the boundary) and outside (i.e. outside the boundary). All or part of the earth's surface may be divided into a number of areas of different or equal size and shape, such as circles, rectangles or polygons, and each of these areas may have assigned a unique identifier, referred to here as the identifier. Thus it is possible, for example, to determine based on the position the entering into the closed area of a region and thus the identifier assigned to this region based on the position.

Identification information (referred to in FIG. 1 as order data) is any information that uniquely identifies a transport article. The identification information can be a character string from a predetermined character set (e.g. digits from 0 to 9 and/or letters from A to Z) with a predetermined length (e.g. 16 characters) or a code, such as a barcode known to the state of the art or QR code.

The first checking information may be a tuple comprising at least the location information and the identification information. Furthermore, the first checking information may include further information such as a unique identifier concerning the transport of the articles and information concerning the dispatcher, the recipient, the transported, the articles, the destination and/or the route to the destination, etc.

After step 210 of generating the first checking information, it is stored in a step 220 to store it in a central processing system described in detail below. The first checking information may be stored in an appropriate manner - in plain text or encoded by a predetermined method—as a data set in a database of the central processing system.

The location information concerning the destination is transmitted in a step 230 for transmission to a mobile device of the transporter, which is referred to as a monitoring device and described in more detail below. The transmission can take place by any suitable means, in particular by e-mail, SMS or as a data packet. It is preferred if a software application (app) is executed on the monitoring device and the location information is transmitted to the software application as a data packet via push service or pull service.

In addition, in a step 240, the identification information is transmitted to the recepient. This step 240 can be performed in any temporal relationship to step 230 (i.e., before, at the same time, or afterwards). Steps 230 and 240 can also be executed in a single step. The identification information can be provided via any suitable electronic or non-electronic transmission path. In particular, transmission can be by fax, e-mail, SMS, data packet or in paper form as a letter.

The transporter carries out the transport after taking over the articles and receiving the location information concerning the destination. For example, the transporter can follow a specified route, which was transmitted together with the location information.

For a successful and proper handover, the transporter must be at the destination, i.e. the transporter must have transported the articles to the destination and have handed them over to the recipient there. Whether the handover by the transporter actually takes place at the destination is determined by the monitoring device in a step 250 by a location information concerning the location at which the transported articles are handed over to the recipient. For this purpose, the monitoring device has, for example, a module for position determination, as described in more detail below.

The location information determined in step 250 may, for example, include location coordinates, in particular Cartesian location coordinates, location coordinates in accordance with the GPS, a CID or an identifier identifying an area around a location.

In step 260, the identification information, which has been transmitted to the recipient, is then read into the monitoring device. For example, step 260 is performed after the articles have been transferred from the transporter to the recipient.

In connection with step 260, an additional step 255 can be used to check whether the location information determined in step 250 and the location information concerning the destination transmitted in step 230 match. The two location information are considered to match inasmuch as the location is in a specific area around the destination. For example, it can be checked whether the location at which the handover takes place is located in the area around a location (i.e. within the imaginary boundary or within the closed area) identified by the identifier. Based on the result of the check, a corresponding location verification result information can be generated, indicating whether or not the location information matches.

In addition, if it is determined in step 255 that the location information does not match, the monitoring device may be disabled and may not permit reading of the identification information in step 260.

In addition, a corresponding indicatrion can be displayed by means of a module for display on the monitoring device and/or a corresponding notification can be transmitted by means of a module for transmission to the central processing system. In the latter case, this notification may be stored in association with the stored first checking information in the central processing system.

The reading in of the identification information in step 260 can be perfomed in any suitable way. The monitoring device preferably scans the identification information transmitted to the recipient in step 230. For this purpose, the monitoring device may have a suitable module for scanning and processing the identification information (e.g. a scanner for a barcode or a QR code). The monitoring device may also have an alphanumeric keypad which is used by the transporter or the recipient to enter the identification information into the monitoring device in the form of a string of characters.

The monitoring device generates second checking information from the location information determined in step 250 concerning the location and the identification information, which was read in in step 260. In step 270, the second checking information based on the location information determined in step 250 and the identification information is transmitted by the monitoring device to the central processing system. The transmission can again take place via any suitable transmission path, in particular by e-mail.

Method 200 concludes with step 280. In step 280, the central processing system checks whether the first checking information generated in step 210 matches the second checking information transmitted in step 270. The two pieces of checking information are considered to be consistent if the identification information is identical and the location is within a specified area around the destination. For example, it can be checked whether the location where the handover takes place is within an area around a location (i.e. within the imaginary boundary or within the closed area) identified by the identifier.

If step 255 is performed and the location verification result information is generated, the monitor may generate the second checking information based on the location verification result information and the identification information read in in step 260 and may transmit it to the central processing system in step 270. In step 280, the central processing system then checks again whether the first checking information generated in step 210 matches the second checking information transmitted in step 270. The two checking information are considered to match if the location verification result information indicates that the location information determined in step 250 and the location information concerning the destination transmitted in step 230 match, and if the identification information is identical.

The handover of the articles to be transported is considered only successful and thus proper, if the checking in step 280 results in that the first checking information and the second checking information match.

In addition, the method may, if necessary, include a further step in which the result of step 280 is transmitted to the monitoring device and/or the dispatcher of the articles being transported. This informs the dispatcher that the articles have been properly handed over to the recipient and that the transport is complete. In addition, the transporter can be certified that he has handled the transport properly.

The procedure according to the first embodiment of the invention described above ensures that the transported articles are handed over to the correct recipient at the correct place (“correct” her means “intended” and “specified”).

According to a further embodiment of the method 200 described with reference to FIG. 2 according to the first embodiment, it can additionally be ensured that the handover of the transport articles to the correct recipient not only takes place at the correct place, but also at the correct time (i.e. within a certain period of time).

For this purpose, the first checking information is also based on time information. In step 210, the time information is also taken into account when generating the first checking information. The time information concerns a period in which the transported articles are to be handed over to the recipient, and it may be available in any suitable time format, such as a start time and an end time of the period or a start time and a duration of the time period, each related to a specific time zone (e.g. the coordinated world time, UTC).

After generating the first checking information, in addition to the location information concerning the destination, the time information is transmitted to the transporters monitoring device. For this purpose the time information can be transmitted together with the location information concerning the destination in step 230 or in a separate step for transmission.

For a successful and proper handover of the transported articles, according to this embodiment time information concerning the time at which the transported articles are handed over to the recipient is determined. For this purpose, the monitoring device has an additional module for time determination. This determines a time in a certain format related to a certain time zone as time information.

The transporter's monitoring device then checks whether the determined time information matches the time information transmitted to the monitoring device. The two time information are checked to see whether they match to the extent that the determined time at which the handover takes place is within the specified period. For example, there can be determined whether the determined time is after the start time but before the end time of the time period. There may can also be generated a time verification result information that specifies whether the time information do match or not.

In addition, in the event that the time information do not match, the monitoring device may be locked and may not allow the identification information to be read in.

In addition, a corresponding indication may be displayed by a module for display on the monitoring device and/or a corresponding notification may be transmitted by a module for transmission to the central processing system. In the latter case, the notification may again be stored in the central processing system associated to the stored first checking information.

After reading in the identification information, the monitoring device may, in a further embodiment of the first embodiment, additionally generate the second checking information on the basis of the determined time information or the time verification result information and may transmit the second checking information generated in this way to the central processing system. The central processing system then additionally checks whether the checking information match to the extent that the time indicated by the transmitted time information is within the time period, or whether the time verification result information indicate that the time information match.

In a further version of the first embodiment, the method may also include a step for marking the first checking information. This step is performed by the central processing system after checking the checking information. In particular, if the checking information as described above are considered to match, the first checking information stored in the central processing system may be marked accordingly. In particular, this marking may include deactivating or invalidating the first checking information.

It may be advantageous if verifying the checking information also includes verifying whether the first checking information has already been deactivated or is still activated. In the first case, an appropriate notification may then be sent to the monitoring device for display on it, and/or appropriate information may be stored together with the first checking information. In this case, the verifying of the checking information is no longer carried out. In the other case, the checking information is verified.

By marking the first checking information and checking the marking, it can be ensured that the first checking information can only be verified successfully once, and that the handover can therefore only be regarded once as having been properly performed.

According to a second and third embodiment, method 200 is extended according to the first embodiment such that either a third checking information for the particular transport of the particular articles is generated based on a location information concerning the start location, i.e. the location where the articles are to be handed over from the dispatcher to the transporter, and the identification information, or the generated first checking information is further based on the location information concerning the start location. This ensures that not only the handover from the transporter to the recipient takes place correctly, but also the handover from the dispatcher to the transporter. This enables an almost continuous monitoring of the transport.

The method 200 according to the second embodiment comprises a corresponding step for generating the third checking information based on the location information concerning the start location and based on the identification information and storing the third checking information in the central processing system.

After generating and storing the third checking information, the location information concerning the start location may be transmitted to the transporter or its monitoring device. This can be done together with steps 230 or 240 or as an independent step. In addition, the identification information is transmitted to the dispatcher. This can be done according to step 240 via any suitable electronic or non-electronic transmission path. In particular, transmission can take place as a fax, e-mail, SMS, data packet or in paper form as a letter.

When the articles to be transported are handed over, the dispatcher then submits the identification information to the transporter for reading them in. The transporters monitoring device determines a location information concerning the place where the transported articles are handed over and enables the identification information to be read in.

The monitoring device may also check whether the determined location information relating to the location at which the articles are handed over and the transmitted location information relating to the starting location coincide. This is the case if it is determined that the location is within an area around the start location according to the determined location information. The area around the start location—the same applies to the area around the destination—is predetermined or corresponds to the area identified by the identifier. Similarly, in accordance with the result of checking the location information, the monitoring device may generate corresponding location verification result information indicating whether or not the location information match.

In addition, in the event that the location information do not match, the monitoring device may be disabled and may not enable the reading in of the identification information.

Based on the read-in identification information which can be read in in accordance with step 260 described above and the determined location information or the location verification result information, the monitoring device generates fourth checking information and transmits it to the central processing system. The transmission of the fourth checking information corresponds to the transmission of the second checking information described in step 270.

Through the central processing system, the third checking information and the fourth checking information are checked by the central processing system to see whether they match to the extent that the identification information is identical and the location is in a specified area around the starting location, or the location verification result information indicates that the location information match at the monitoring device. In the event that the central processing system detects a match, the verification of proper handover shall be considered successful.

In addition, the result of the verification can be stored as corresponding information together with the third checking information in the central processing system and a corresponding notification can be transmitted to the transporters monitoring device for display on it. Saving the corresponding information corresponds to marking the third checking information. This gives the third checking information the information that the articles to be transported have been properly handed over from the dispatcher to the transporter. In particular, this marking can include deactivating or invalidating the third checking information. According to the first and second embodiment, the first and third checking information is activated and stored in the central processing system.

Verifying that the third checking information matches the fourth checking information may, if the marking or deactivation of the third checking information is used, also includes a check to see if the third checking information has already been deactivated. In such a case, i.e. if the third checking information has already been deactivated, the check whether the checking information match can then be omitted. Preferably, the third checking information is then provided with appropriate information and a notification is sent to the monitoring device for display on it.

According to the third embodiment of method 200, the first checking information in step 210 is then additionally generated based on the location information concerning the start location.

After the first checking information has been generated, the location information regarding the start location can be transmitted to the transporter or its monitoring device. This can be done together with steps 230 or 240 or as an independent step. In addition, the identification information will be transmitted to the dispatcher. This can be done according to step 240 via any suitable electronic or non-electronic transmission path. In particular, transmission can take place as a fax, e-mail, SMS, data packet or in paper form as a letter.

When the articles to be transported are handed over, the dispatcher then submits the identification information to the transporter for reading them in. The transporters monitoring device determines a location information concerning the place where the transported articles are handed over and enables the identification information to be read in.

The monitoring device may also check whether the determined location information relating to the location at which the articles are handed over and the transmitted location information relating to the starting location match. This is the case if it is determined that the location is within an area around the start location according to the determined location information. The area around the start location—the same applies to the area around the destination—is predetermined or corresponds to the area identified by the identifier. As described above, the monitoring device may also generate, in accordance with the result of the location information check, corresponding location verification result information indicating whether or not the location information match.

In addition, in the event that the location information do not match, the monitoring device may be disabled and may not enable the read-in of the identification information.

Based on the read-in identification information which can be read in according to step 260 described above and the determined location information or the location verification result information, the monitoring device generates third checking information—understandably, third checking information here does not refer to the third checking information according to the second embodiment described above—and transmits it to the central processing system. The transmission of the third checking information corresponds to the transmission of the second checking information described in step 270.

Through the central processing system, the first checking information and the third checking information are checked as to whether they match to the extent that the identification information is identical and the location is in a particular area around the starting location or the location verification result information indicates that the location information coincides at the monitoring device. In the event that the central processing system detects a match, the verification of proper handover shall be considered successful.

In addition, the result of the verification can be stored as corresponding information together with the first checking information in the central processing system, and a corresponding notification can be transmitted to the transporters monitoring device for display on the latter. Saving the corresponding information corresponds to marking the first checking information. This provides the first checking information with the information that the articles to be transported have been properly transferred from the dispatcher to the transporter. This marking can include activating the first checking information. In contrast to the first and second embodiments, the first checking information is not stored in activated form on the central processing system according to the third embodiment.

Verifying that the first check information matches the third check information may, if the marking or activation of the first checking information is used, also include a check to see whether the first checking information has already been activated or deactivated due to a proper handover to the recipient. In such a case, i.e. if the first checking information has already been activated or deactivated, checking whether the checking information match can then be omitted. Preferably, the first checking information is then provided with appropriate information and a notification is sent to the monitoring device for display on it.

To further improve safety, when transmitting the second or fourth checking information in accordance with the second embodiment or the second or third checking information in accordance with the third embodiment, the monitoring device may additionally transmit information identifying the monitoring device (hereinafter referred to as monitoring device ID). In the case of a mobile terminal device according to the GSM or UMTS standard as a monitoring device, the so-called International Mobile Station Equipment Identity (IMEI) can be transmitted as a monitoring device ID, for example, because this uniquely identifies the mobile terminal device worldwide. This information is then preferably also stored in the central processing system in connection with checking information. There, the monitoring device ID is stored for the particular order (for example, as part of the first checking information), and during the verification of the second checking information it can then be determined whether the correct driver or transport vehicle has handed over the articles.

For this purpose, when generating the first checking information, the monitoring device is linked to the first checking information by generating the first checking information also on the basis of the monitoring device ID. The monitoring device ID can be any ID that uniquely identifies the monitoring device, for example the IMEI of a smartphone, the IMSI of a smartphone (slightly less advantageous, as not entirely unique to the smartphone but only to its smart card), the MAC address of the monitoring device, or the like. This ID is then also used to form the basis for the first checking information. This then links the monitoring device to the order.

For example, a smartphone could be used as a monitoring device. By assigning a certain smartphone to a certain driver in the central processing system (and this assignment is also secured, for example, by means of a PIN or other security features that identify the driver). This ensures that only the driver assigned for a particular transport is able to hand over the articles to the recipient at the point of delivery in such a way that an inspection of the second checking information by the central processing system confirms correct delivery. For this purpose, the generation of the second checking information is also based on the monitoring device ID.

This also ensures that only the assigned driver loads the articles onto (his) transport vehicle at the start of the transport. To this end, the system requires that when the articles are loaded, the monitoring device ID is transmitted by the monitoring device to the central processing device to check that “the right” driver has received the articles for transport.

In another embodiment, information that uniquely identifies the vehicle is also included when the first checking information is generated. For this purpose, for example, the app on the smartphone forming the monitoring device can be designed in such a way that it prompts the driver to enter the vehicle identification number of the transport vehicle at the start of the transport. This vehicle identification number can then be used as a further basis for generating the first checking information. This assigns also a unique vehicle to the shipment. The assignment can already have taken place in advance when the order was created in the logistics center of the transport agent by assigning a specific vehicle (via the vehicle ID, such as the chassis number or, although less secure, the vehicle number plate) and a specific driver (via the smartphone ID) to the order. The reading in or input of the vehicle ID by the driver at the start of the transport then ensures that firstly the correct driver (by checking the monitoring device ID) and secondly the correct vehicle (by checking the vehicle ID) carry out the transport. For this purpose, the monitoring device transmits both, the monitoring device ID and the vehicle ID, to the central processing system at the start of transport or loading of the articles and checks whether these correspond to the corresponding information which served as the basis for generating the first checking information.

By using both the vehicle ID and the monitoring device ID as an (additional) basis for generating the first checking information, both the handover by a “wrong driver” and the transport by a “wrong vehicle” can be avoided. By using both the monitoring device ID and vehicle ID as the basis for generating the initial checking information, both are linked to each other and to the other handover data (location and time, if any), further increasing safety.

At the handover location, the monitoring device ID and the vehicle ID are also (again) transmitted to the central processing device (e.g. as part of the second checking information or by the second checking information also being based on it) in order to “identify” both the driver and the vehicle. This ensures that the handover is carried out by the right driver and the right vehicle.

In addition to a mobile monitoring device, e.g. in the form of a smartphone, the monitoring device can also be permanently installed in a transport vehicle, for example as an on-board unit (OBU). In this case, the monitoring device ID is then permanently linked to the vehicle ID because the monitoring device is permanently mounted in a vehicle with a specific vehicle ID. In this embodiment, it is therefore not necessary for the driver to enter or to read in the vehicle ID at the start of the transport. Rather, the assignment of vehicle ID monitoring device ID is already specified by the fixed mounting of the OBU. However, in a preferred embodiment, the vehicle ID is still used to generate the first checking information, as is the monitoring device ID. For example, if the monitoring device has been removed from the vehicle, this can be done by the monitoring device requesting an input of or a reading in of the vehicle ID when the articles are picked up or when the articles are handed over at the handover location. This information is then transmitted to the central processing system and compared with the preset information for this transport.

Due to the fixed association between vehicle and monitoring device, in this embodiment (initially) no assignment to a specific driver is made. However, such an assignment can be made, for example, by selecting a particular driver for a particular transport and generating a particular PIN or password for that driver, which is then set in the monitoring device as login information for that particular transport. With this PIN (or a password generated in this way), the specific driver for this specific transport must log on to the monitoring device in order to receive the articles. In this way, a complete allocation (and verification) of vehicle, driver, articles and handover location to a specific transport can then take place and be verified at handover by the central processing system. This ensures that when the articles are loaded at the beginning of the transport, the right driver loads the articles onto the right vehicle and that the right driver unloads the right articles from the right vehicle at the right place and hands them over to the right recipient.

The checking information transmitted between the monitoring device and the central processing system is preferably coded by means of a predetermined procedure. For example, a symmetric encryption method with a key deposited either in the monitoring device and the central processing system or provided by the central processing system at the request of the monitoring device prior to the transmission of the checking information may be used here.

It is also preferred when communication between the central processing system and the monitoring device is via a secure end-to-end connection, for example using Secure Sockets Layer (SSL) as the network protocol.

In the central processing system, the checking information stored there can be stored together with a history of their use. This means that with regard to the handover from the dispatcher to the transporter and the handover from the transporter to the recipient, the time, the checking information transmitted by the monitoring device, the result of the verification of the checking information and the IMEI of the monitoring device can be stored.

The steps described above for the method according to the invention for transfer from the dispatcher to the transporter and the transfer from the transporter to the recipient can be applied accordingly to intermediate locations, via which the transport is to take place.

FIG. 3 shows a system 300 for checking the proper handover of a transported article at its destination. The system 300 comprises a monitoring device 320 and a central processing system 340, each according to an embodiment of the present invention.

The monitoring device 320 according to an embodiment is intended for checking the proper handover of the transported articles at the destination.

The monitoring device 320 can be connected to the central processing system 340. The connection between the monitoring device 320 and the central processing system 340 can be made via any suitable connection 360 such as a network connection or a mobile radio connection.

The central processing system 340 is arranged to generate and store first checking information for the transport of the articles to the destination, which are based on location information concerning the destination and based on the identification information, as described in more detail below.

The monitoring apparatus 320 comprises: A module for receiving location information relating to destination 322 from the central processing system 340; a position determining module 324 adapted to determine the location information relating to the location at which the transported articles are handed over to the receiver; a module for reading in the identification information 326; and a module for transmitting second checking information 328, which is based on the determined location information relating to the location and based on the identification information, to the central processing system 340.

Furthermore, the monitoring device 340 may include a module for checking whether the determined location information and the transmitted location information relating to the destination match. The module can also be set up to generate a corresponding location verification result information based on the result of the check, indicating whether the location information match or do not match. The second checking information module 328 may in this case be configured to transmit second checking information to the central processing system 340 based on the location verification result information and the identification information.

The central processing system 340 is configured, as further described below, to check whether the first checking information match the second checking information to the extent that the identification information is identical and the location is within a particular area around the destination location or if the location verification result information indicates that the location information at the monitoring apparatus 320 match. The central processing system 340 only considers the check that the articles to be transported have been handed over correctly to be successful if the first checking information matches the second checking information.

In embodiments, the monitoring device 320 may further comprise a time determination module 330 arranged to determine time information relating to the time at which the transported articles are handed over to the recipient, a module for displaying information or notifications transmitted from the central processing system and instructions for reading in the identification information 332, and a module for controlling the operation of the modules of the monitoring device 320 and a module for generating and transmitting notifications 336 to the central processing device 340. The module for reading in the identification information 326 can comprise a scanner for barcode 326-1, a scanner for QR code 326-2 or a module for entering alphanumeric characters 326-3.

The 340 central processing system is configured to verify that the articles to be transported are handed over correctly at their destination. The 340 central processing system can be connected to the 320 monitoring device via any 360 suitable connection.

The central processing system 340 comprises: a module for generating the first checking information 342 for transporting the transported articles to the destination based on location information concerning the destination and based on the identification information; a module for storing the first checking information 344, for example, in a database 380; a module for transmitting the location information 346 concerning the destination to the monitoring device 320; and a module for transmitting the identification information 348 to the receiver; a module for receiving second checking information 350 from the monitoring apparatus 320; and a module for checking 352 whether the first checking information match the second checking information to the extent that the identification information is identical and that the location is within a particular area around the destination, or that the location verification result information indicates that the location information match at the monitoring apparatus 320.

The central processing system 340 only considers the check that the articles to be transported have been handed over correctly to be successful if the first checking information matches the seconding check information.

The monitoring device 320 can be a mobile device, in particular a smartphone or a tablet computer, on which a software application (app) is running.

The 340 central processing system can be a cloud-based server environment with one or more servers and a database accessed over a network (e.g. the Internet).

For the skilled person, it is clear that the “destination” in the sense of the above-described embodiments cannot only be the destination at the end of a transport, but also the “starting point” at which the articles are handed over from the dispatcher to the transporter. The “recipient” of the transported articles is then the transporter. The “transport” is thus reduced to the handover at the start location to the transporter, whereby the handover at the start location can already be secured according to the invention. In this way, the method according to the invention can also be used at the start location for protection.

Such a method for handing over an article to be transported from the dispatcher to the transporter, according to a fourth embodiment, comprises the steps of: generating first checking information for a specific transport of a specific transport article based on location information concerning the starting location at which the transport article is to be handed over from the dispatcher to the transporter and identification information identifying the transport article; storing the first checking information in a central processing system; as described above, transmitting the location information concerning the starting location to the transporter or a monitoring device as described above; transmitting the identification information to the dispatcher; determining by the monitoring device location information relating to the location at which the articles to be transported are handed over to the transporter; reading in the identification information into the monitoring device; transmitting second checking information based on the determined location information concerning the location and the identification information by the monitoring device to the central processing system; and checking whether the first checking information matches the second checking information to the extent that the identification information is identical and that the location is in a predetermined area around the starting location. The check that the articles to be transported have been handed over correctly is only regarded as successful if the first checking information matches the second checking information.

Further versions of the method according to the fourth embodiment include steps analogous to the steps of method 200.

Furthermore, at any “intermediate station” this intermediate station can be regarded as a “destination” in the sense of the invention, provided, for example, that only part of the transported articles is handed over to a recipient there.

The method according to the invention is preferably executed as a computer program on one or more computers and controls them. The computers shall include any data processing equipment, including stand-alone PCs, client-server architectures or other networked computer systems, provided that they are suitably equipped and suitable for carrying out the procedure.

The computer program according to the invention is stored preferably on one or more data carriers in such a way that it is readable by the one or more computers, i.e. the monitoring device and the central processing system. The storage is therefore carried out in a machine-readable or computer-readable manner.

1-25. (canceled)

26. Method for checking whether articles to be transported have been handed over properly at their destination, including:
generating first checking information for a specific transport of a specific transport article to a specific destination, at which the transport article is to be handed over to a recipient, based on location information concerning the specific destination and based on identification information identifying the transport article;
storing the first checking information in a central processing system;
transmitting the location information concerning the specific destination to a monitoring device of the transporter, wherein the monitoring device comprises a position determining module, and transmitting the identification information to the recipient;
for successfully checking of the handover, determining, by the monitoring device, location information relating to the location at which the articles to be transported are handed over to the recipient;
reading in the identification information into the monitoring apparatus;
transmitting second checking information based on the determined location information relating to the location and based on the identification information by the monitoring apparatus to the central processing system; and
checking whether the first checking information matches the second checking information to the extent that the identification information is identical and that the location is within a specific area around the destination.

27. The method of claim 26, further comprising:
verifying whether the determined location information and the location information relating to the specific destination coincide to the extent that the location is within a particular area around the destination, and
generating location verification result information indicating whether or not the location information coincides based on the result of the verification,
wherein the second checking information is generated based on the location verification result information and the identification information, and
wherein the first checking information and the second checking information are considered to match if the location verification result information indicates that the determined location information and the location information relating to the specific destination match and if the identification information is identical.

28. The method according to claim 26, wherein
reading in the identification information includes scanning the identification information transmitted to the recipient by the monitoring device, or inputting the transmitted identification information into the monitoring device.

29. The method according to claim 26, wherein
the first checking information is further generated based on time information relating to a specified period of time, during which the transported articles are to be handed over to the recipient, and is transmitted to the transporter's monitoring device, wherein the method further comprises:
determining time information relating to the time at which the transported articles are handed over to the recipient by a time determination module of the monitoring device; and
checking whether the determined time information and the time information relating to the specified period of time coincide to the extent that the time is within the specified time period, and
verification of the proper handover of the articles to be transported is considered successful only if the determined time information and the time information relating to the specified time period coincide.

30. The method according to claim 29, wherein
the second checking information may also be based on the determined time information, and
verifying the checking information may further include verifying whether the first checking information matches the second checking information to the extent that the time is within the specified time period.

31. The method according to claim 26, further comprising:
marking the first checking information when the first checking information matches the second checking information,
wherein the marking of the first checking information includes in particular deactivating the first checking information, and
where in verifying whether the checking information match includes checking whether the first checking information has already been deactivated.

32. The method according to claim 26, further comprising:
generating the first checking information based on a monitoring device ID that identifies the monitoring device; and
generating the first checking information based on a vehicle ID identifying the transport vehicle.

33. The method according to claim 32, further comprising:
at the beginning of the transport, transmitting the monitoring device ID to the central processing system and checking the monitoring device ID by comparison with the first checking information; and
at the beginning of the transport, transmitting the vehicle ID to the central processing system and checking the vehicle ID by comparison with the first checking information.

34. The method according to claim 32, further comprising:
at the handover location, transmitting the second checking information to the central processing system, which is based, inter alia, on the monitoring device ID and the vehicle ID, and verifying the second checking information, and thus the monitoring device ID and the vehicle ID, by comparison with the first checking information.

35. The method according to claim 26, wherein
the monitoring device is a mobile monitoring device, in particular a tablet or smartphone, which is assigned in the central processing system either permanently or at least for a specific transport by assignment to a specific driver, and
the monitoring device is an on-board unit (OBU) fixed to a particular vehicle and in the central processing system the monitoring device is linked to or associated with the particular vehicle by its monitoring device ID by association with the vehicle ID of the particular vehicle.

36. The method according to claim 26, wherein
a password is assigned to a driver either permanently or for a specific transport, by which he must log on to the monitoring device,
the monitoring device is configured such that the password assigned to the driver at the beginning of the transport is requested by the driver for login, and
the password and the driver associated with the password are stored in the central processing apparatus and, optionally, the first checking information is generated based thereon.

37. The method according to claim 26, further comprising:
generating third checking information for a specific transport of specific transport articles based on location information related to a starting point, at which the transport articles are to be handed over from a dispatcher to the transporter and based on the identification information;
storing the third checking information in the central processing system;
transmitting the identification information to the dispatcher;
transmitting the location information related to the starting point to the monitoring device of the transporter;
determining a location information related to the location, at which the transport articles are handed over to the transporter, by the monitoring device;
reading in the identification information into the monitoring device;
transmitting fourth checking information based on the determined location information related to the location and based on the identification information to the central processing system by the monitoring device; and
checking whether the third checking information matches the fourth checking information to the extent that the identification information is identical and that the location is located within a certain area around the start location.

38. The method according to claim 37, further comprising:
marking the third checking information if the third checking information matches the fourth checking information, wherein the marking of the third checking information includes deactivating the third checking information, and
wherein verifying whether the checking information match includes a check includes determining whether the third checking information has already been deactivated.

39. The method according to claim 26, wherein the identification information is a barcode or a quick response (QR) code and/or the location information is location coordinates, in particular cartesian location coordinates or Global Positioning System (GPS) location coordinates, or an identifier which identifies an area around a location, such as a geofence identifier (ID).
